(19) United States
(12) Patent Application Publication
(10) Pub. No.: US 2015/0220695 A1
(43) Pub. Date: Aug. 6, 2015

(54) METHODS OF USING TELEMEDICINE TO INCREASE USAGE OF HEALTH CARE SYSTEMS

(71) Applicant: Carena, Inc., Seattle, WA (US)

(72) Inventors: Amber Ratcliffe, Seattle, WA (US); Peggy A. Carver, Sammamish, WA (US)

(21) Appl. No.: 14/486,301

(22) Filed: Sep. 15, 2014

Related U.S. Application Data
(60) Provisional application No. 61/877,689, filed on Sep. 13, 2013.

(51) Int. Cl. G06F 19/00; G06Q 30/02

(52) U.S. Cl. CPC G06F 19/3418; G06F 19/322; G06F 19/328; G06Q 30/0255; G06Q 30/0269

(57) ABSTRACT

The present invention provides methods for attracting consumers to a medical care system. The methods include presenting a first communication to a consumer, wherein the communication provides an offer for access to a telemedicine session and provides instructions for the consumer to electronically access additional information regarding the telemedicine session; requesting personal information from the consumer when the consumer follows the instructions to electronically access additional information regarding the telemedicine session; and providing information to the consumer regarding access to medical care in a medical care system when the consumer provides the requested personal information.

### RELATED APPLICATIONS

This application claims the benefit of U.S. Provisional Application No. 61/877,689, filed Sep. 13, 2013, which is incorporated herein by reference in its entirety.

### BACKGROUND

Health systems are under great economic pressure to acquire and retain a large patient base. In the past, one method for identifying new patients was to operate freestanding walk-in clinics with extended hours. Patients who did not have a primary care provider would utilize the clinics and the system would be able to collect patient contact information and further market to the patients in hopes of establishing a long-term relationship with the health system's primary and specialty care services. Opening and operating these clinics is very expensive and is often a loss leader. Furthermore, the patient base is limited by geography as only patients who live in close proximity would utilize the clinics.

Also, some existing patients of a health system may have not utilized services for an extended period of time. By identifying additional health systems service engagement opportunities such as preventative screening tests and vaccinations during an urgent care service encounter, patients can become ‘re-activated’ providing additional value to the health system.

A need exists for a low cost method for acquiring new patients or re-activating existing patients in a health system that does not require opening and operating new clinics.

### BRIEF SUMMARY OF THE INVENTION

In one aspect a method is provided for attracting consumers to a medical care system where the method includes presenting a first communication to a consumer, wherein the communication provides an offer for access to a telemedicine session and provides instructions for the consumer to electronically access additional information regarding the telemedicine session; requesting personal information from the consumer when the consumer follows the instructions to electronically access additional information regarding the telemedicine session; and providing information to the consumer regarding access to medical care in a medical care system when the consumer provides the requested personal information, thereby attracting consumers to a medical care system. In certain embodiments, information provided to the consumer regarding access to medical care in a medical care system is customized based on their personal information. In some embodiments, the information regarding access to medical care in a medical care system is selected from the group consisting of locations of clinics, medical centers, hospitals, doctors' offices and hours of operation. In some embodiments, the location of medical services communicated to the consumer is within a 100 mile geographic distance from the consumer.

In some embodiments, the information regarding access to medical care in a medical care system is pricing of medical services. In some embodiments, the pricing of medical services comprises a membership service wherein a flat fee is paid for a period of time that covers medical care in the medical care system. In certain embodiments, the medical care provided for a flat fee includes a specific menu of services for a discounted price selected from the following group consisting of telemedicine consultations, vaccinations, screening tests, in clinic medical consultations, and/or preventative care visits.

In some embodiments, the information regarding access to medical care in a medical care system comprises biographical information of doctors employed by or associated with the medical care system. In some embodiments, the biographical information is selected from the group consisting of name, office location, medical school, college or university, medical specialty and personal interests.

In some embodiments, the personal information is selected from the group consisting of address, phone number, e-mail, name, age and gender. In some embodiments, the information regarding access to medical care is customized according to the gender or age of the consumer.

In some embodiments, medical information is requested from the consumer. In some embodiments, when medical information is provided by the consumer, the information regarding access to medical care is customized to the medical information.

In some embodiments, the customized information regarding access to medical care is selected from the group consisting of nearby critical care sites, nearby family care sites, and nearby medical sites that deal with a symptom or pathology reported by the consumer.

In some embodiments, the medical information provided by the consumer comprises the medical needs of the consumer. In some embodiments, the information regarding medical needs of the consumer comprises information regarding consumer behavior or clinical information of the consumer.

In some embodiments, the method further comprises providing a telemedicine session to the consumer.

In some embodiments, the telemedicine session comprises collection of medical information and medical examination of the consumer by a medical professional by way of a live electronic communication. In some embodiments, the live electronic communication is selected from the group consisting of video conference; Internet protocol (IP) telephony; live chat, web site-mobile browser teleconference, videoconference or live chat; smartphone teleconference, videoconference or live chat; teleconference, videoconference or live chat through a dedicated application; and telephone call.

In some embodiments, the information requested from the consumer further comprises critical medical information regarding the consumer. In some embodiments, if the critical medical information shows that the consumer is in need of critical medical care, the method further comprises sending a message to the consumer recommending pursuit of critical medical care. In some embodiments, the request for information from the consumer regarding critical medical information is performed using an electronic symptom checker through an electronic medium.

In some embodiments, the communication to the consumer is an electronic communication. In some embodiments, the electronic communication is made through an electronic device. In some embodiments, the electronic device is selected from the group consisting of a personal desktop computer, a laptop computer, a tablet computer, a cellular telephone, a land line telephone, a facsimile machine, a pager, a radio and a television.

In some embodiments, the method includes sending a second communication to the consumer, wherein the second communication comprises information regarding access to medical care in a medical care system. In some embodiments, the second communication to the consumer is an electronic communication. In some embodiments, the electronic communication is made through an electronic device. In some embodiments, the electronic device is selected from the group consisting of a personal desktop computer, a laptop computer, a tablet computer, a cellular telephone, a land line telephone, a facsimile machine, a pager, a radio and a television.

In some embodiments, the information regarding medical services comprises information selected from the group consisting of the location of medical services, the pricing of medical services and what pathologies or symptoms are treated.

In some embodiments, the location of medical services comprises the location of a clinic, doctor's office or hospital. In some embodiments, the personal information from the consumer comprises the location of the consumer. In some embodiments, the location of medical services communicated to the consumer is within a 100 mile geographic distance from the consumer.

In some embodiments, the second communication to the consumer regards medical services that are available that respond to the medical needs of the consumer. In some embodiments, the consumer did not know that the medical services in the second communication were appropriate to their medical needs. In some embodiments, the consumer did not know that the medical services were offered in a manner that was available to the consumer.

In some embodiments, the first electronic communication is provided to the consumer on a web site, through an electronic application, in a phone call, in a facsimile, on a recording provided at a call in number or in a text message. In some embodiments, the first electronic communication is provided to the consumer on a web site.

In some embodiments, the consumer accesses the web site as a result of an Internet search on an Internet browser. In some embodiments, the Internet search comprises searching for medical services. In some embodiments, these medical services are telemedicine services. In some embodiments, the Internet search for medical services comprises a search term selected from the group consisting of medical and online, nurse line, online doctor, medical and phone, medical and remote, talk to a doctor, talk to a nurse, urgent care, immediate care, virtual and medical, web and medical, webcam and medical, clinic, walk-in clinic and online clinic. In some embodiments, the Internet search comprises searching for one or more pathologies or pathological symptoms. In some embodiments, the one or more pathologies are selected from the group consisting of abdomen pathologies, allergies, asthma, bladder pathologies, bronchitis, colds, influenza, chronic obstructive pulmonary disease, ear infection, gall bladder pathologies, kidney pathologies, lung pathologies, migraines, mononucleosis, nasal pathologies, pneumonia, sinus infections, oral pathologies, throat pathologies, tonsillitis, urinary tract infections, whooping cough and yeast infections. In some embodiments, the one or more pathological symptoms are selected from the group consisting of congestion, cough, fever, headache, incontinence, sinus pressure and zinc deficiency.

In some embodiments, the method includes comparing the personal information provided by the consumer to a database of information received from consumers, wherein if the information received from the consumer is not already in the database, the information received from the consumer is added to the database.

In some embodiments, the database is a listing of consumers associated with a medical system.

In some embodiments, the consumers are associated with the medical system by being treated by a doctor employed by or associated with the medical system, attending a clinic, hospital or medical center owned or operated by the medical system.

In some embodiments, the database indicates the last time the consumers interacted with the medical care system.

In some embodiments, the interaction with the medical care system is selected from the group consisting of a visit at a doctor's office, clinic, hospital or medical center that is part of or associated with the medical care system.

In some embodiments, consumers that have not interacted with the medical care system for 12 months or more are sent a second communication, wherein the second communication comprises information regarding medical services. In some embodiments, the consumers sent the second communication have not interacted with the medical care system for 18, 24, 30, 36 or more months.

In some embodiments, the first or second communication is sent to consumers who have a health plan. In some embodiments, the health plan is a health insurance plan that routinely pays a medical system for providing medical services.

Other embodiments will become apparent from the figures below and the Detailed Description.

### BRIEF DESCRIPTION OF THE DRAWINGS

The following drawings form part of the present specification and are included to further demonstrate certain aspects and embodiments.

FIG. 1 shows a flowchart of certain embodiments of telemedicine system to attract particular consumers and collect consumer personal information in an intake process. This flowchart includes collection of the consumer's birthdate or age so it can be determined if pediatric or adult emergency room ‘red flag’ questions should be displayed.

FIG. 2 shows a flowchart of certain embodiments of telemedicine system to attract particular consumers and collect consumer personal information in an intake process. This flowchart includes use of an automated triage to determine emergent issues and to determine primary medical complaint.

FIG. 3 shows a flowchart of further embodiments, including determination of a consumer's eligibility for telemedicine, display of telemedicine options, and subsequent consumer engagement steps.

### DETAILED DESCRIPTION

The disclosure provides a method for acquiring new patients or re-activating existing patients to a health system.

This method includes a combination of advertising, telemedicine services, and consumer entered data to attract particular consumers and collect consumer personal information so that the health system may identify high value leads for further marketing activities. This method also allows for identification of additional consumer engagement opportunities.

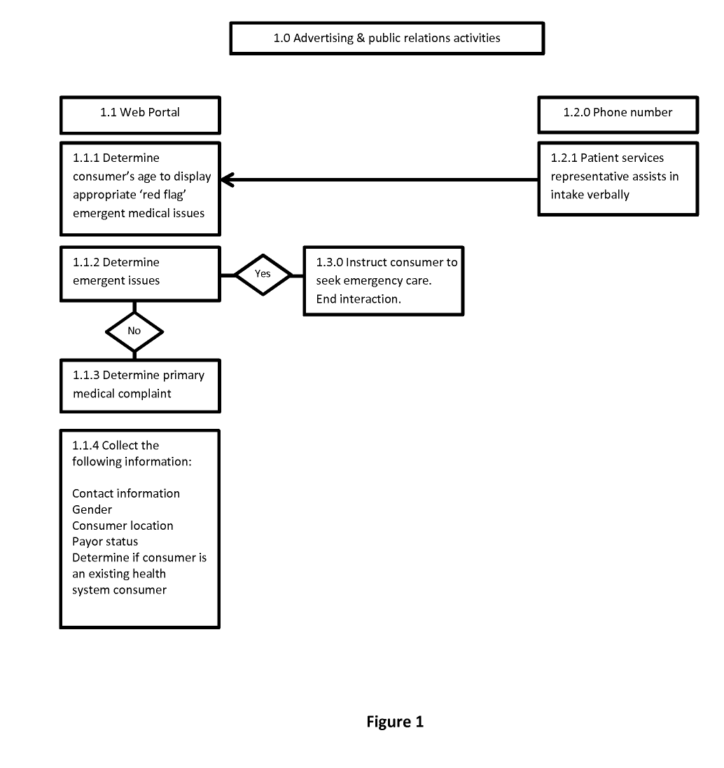

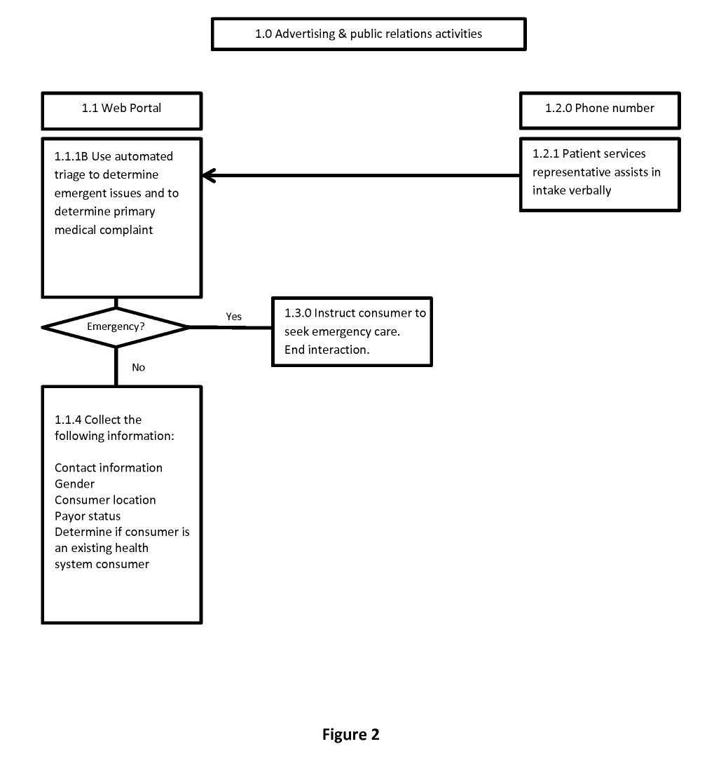

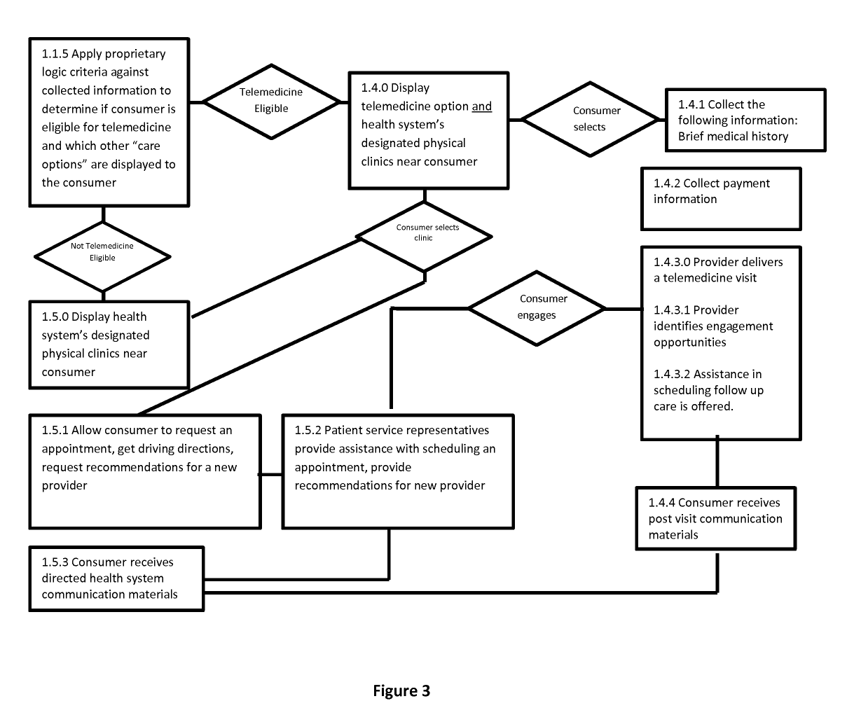

Telemedicine services for acute primary care issues enable health systems to advertise over a wide geographic area to aggregate patients using both broad and targeted methods as shown in FIGS. 1-3. This advertising directs consumers with a medical concern to either a web portal (1.1) or to a phone number (1.2.0) associated with the health system's telemedicine service. If the phone number is called, a patient service representative will verbally walk the consumer through an intake process that is substantially similar to the web portal intake process (1.2.1).

In certain embodiments, the consumer's birthdate or age is collected so it can be determined if pediatric or adult emergency room ‘red flag’ questions should be displayed (1.1.1). According to this embodiment, if any of the red flag symptoms are indicated, the consumer is directed to seek immediate emergency care and the encounter ends with no further data collection (1.3.0). If no red flag symptoms are indicated, the consumer is asked to identify their primary symptom(s) or condition(s) (1.1.3).

Alternatively a ‘symptom checker’ that allows the consumer to indicate their medical issue and level of severity could be used to identify emergent medical situations and primary symptom(s) or condition(s). As used herein, a symptom checker can be any computer program that allows an automated triage of a subject using the symptom checker. In certain embodiments, the symptom checker provides a subject lists of possible symptoms for a subject to choose from. Based on the input from the subject the symptom checker can then provide a preliminary diagnosis based on the combinations of symptoms chosen. According to certain embodiments, the symptom checker provides a questionnaire wherein a subject is asked a series of questions to arrive at a preliminary diagnosis. These questions can include questions about various physical parameters of the body of the subject, as well as questions regarding symptoms that the subject may be experiencing. In certain embodiments, questions regarding symptoms can lead to the symptom checker asking other specific questions to arrive at a more detailed description of a set of symptoms thereby increasing the accuracy of the preliminary diagnosis. For example, a symptom checker could ask a subject first if they felt feverish. If the subject replied “yes” then the subject checker would ask the subject if they had measured their body temperature.

Based on the preliminary diagnosis provided by the symptom checker, the symptom checker can then suggest that the subject receive telemedicine from a medical provider or proceed to a local clinic or emergency department if in-person evaluation or more critical care is needed.

In additional embodiments, the consumer goes through a series of intake questions (1.1.4). The consumer can enter consumer information which may include name, physical or permanent address, email address, phone number, video chat ID, instant messaging ID, gender, current location, health insurance information, existence of a current primary care provider relationship, if they have a current relationship with the health system, if so, who is their primary care provider and in which clinic.

According to other embodiments, intake questions are used to determine if the consumer is eligible for telemedicine based on a series of factors that include age, gender, symptoms, government payer status, and consumer's current location (1.1.5). This method can include logic based on consumer indicated symptom(s) or conditions(s), age, gender, and legal limitations based on payer status or current location to determine if telemedicine is clinically appropriate care option.

Consumers who are telemedicine eligible (1.4.0) can be allowed to select telemedicine and proceed with further intake for a telemedicine visit. They are also displayed physical clinic types and locations based on their location and primary symptom(s) or condition(s).

In other embodiments, if the consumer selects telemedicine, they answer additional intake questions (1.4.1) that include a detailed description of their symptom(s) or condition(s), current medications, medication allergies, recent surgeries, pain scale, preferred mode of communication for the medical consultation, best form of contact, preferred pharmacy, follow-up information.

Consumers can then enter detailed payment information (1.4.2), which may include credit card numbers, expiration dates, billing address, insurance carrier, group number, and member number. Additionally, for direct-pay, the consumer may opt to use 3^{rd} party billing such as PayPal, Amazon Billing, or another 3^{rd} party billing alternative.

In certain embodiments, the consumer is then contacted by the medical provider who collects a medical history, performs a medical examination, diagnosis, and provides a personalized treatment plan, which may include a prescription (1.4.3.0).

During the course of the visit, the medical provider may identify health system engagement opportunities (1.4.3.1) for primary care follow up visits, screening tests, vaccinations, or clinically appropriate testing by asking age and gender appropriate questions of the consumer around major risk areas. The provider can also identify or confirm if the consumer has a primary care provider.

In other embodiments, the provider will offer to have a patient services representative follow up with the consumer to provide personalized recommendations for an affiliated primary care provider or assistance in scheduling any follow up care or testing at health system facilities (1.4.3.2).

If the consumer requests assistance from a patient services representative (1.5.2), the request can be forwarded to a patient service representative who will contact the consumer by their preferred mode of communication which may include phone, email, text message, instant message, or video chat. Patient service representatives can provide recommendations for a new provider within the system or assistance setting-up an appointment at a clinic within the system.

In certain embodiments, after the medical consultation, the consumer will receive a series of communications (1.4.4) which may include a visit summary, treatment plan, satisfaction survey(s), solicitation for online service reviews, solicitation for marketing reviews, and targeted marketing communications (1.5.3) based on information gathered in the web portal, phone, or medical consultation.

Consumers who are not telemedicine eligible (1.5.0) can be informed that they are not eligible and optionally are only shown physical clinic types and locations based on their location and primary symptom(s) or condition(s).

In additional embodiments, if the consumer or requestor selects a physical clinic, they are given options that may include entering additional information to request personalized recommendations for a primary care provider, follow-up from a patient services representative to schedule an appointment, schedule an appointment themselves with a software application that allows them to see available locations and appointment times, get driving directions, or pre-register for a clinic to reduce intake paperwork at the clinic (1.5.1).

All consumer information entered into the web portal or by a patient services representative, regardless of whether or not they choose to further interact with any of the available “care options” displayed (1.1.5) can be entered into a database.

The database of detailed information collected in the web portal or over the phone can be filtered by a variety of factors such as location, age, insurance status, and presenting condition to output particular individuals appropriate for targeted follow up marketing programs such as women's health, mammography screening, birth centers, pediatric services, and orthopedic services. This ability to target particular individuals can decrease the overall cost of marketing in a less targeted fashion.

These marketing programs may include direct mail, email, seminars, webinars, and other marketing programs related to health system services.

General marketing materials such as health publications can also be targeted towards consumers with the highest ability to pay and maintain a brand connection with the health system in order to improve patient acquisition and conversion over time. The present invention is not to be limited in scope by the specific embodiments described herein. Indeed, various modifications in addition to those described herein will become apparent to those skilled in the art from the foregoing description and the accompanying figures. Such modifications are intended to fall within the scope of the appended claims.

1. A method of attracting consumers to a medical care system comprising:
a) presenting a first communication to a consumer, wherein the communication provides an offer for access to a telemedicine session and provides instructions for the consumer to electronically access additional information regarding the telemedicine session;
b) requesting personal information from the consumer when the consumer follows the instructions to electronically access additional information regarding the telemedicine session; and
c) providing information to the consumer regarding access to medical care in a medical care system when the consumer provides the requested personal information, thereby attracting consumers to a medical care system.

2. The method of claim 1, wherein the information regarding access to medical care in a medical care system is selected from the group consisting of locations of clinics, medical centers, hospitals and doctors' offices and hours of operation, biographical information of doctors employed by or associated with the medical care system, and pricing of medical services.

3.-9. (canceled)

10. The method of claim 1, wherein medical information is requested from the consumer, wherein when medical information is provided by the consumer, the information regarding access to medical care is customized to the medical information, wherein the customized information regarding access to medical care is selected from the group consisting of nearby critical care sites, nearby family care sites, and nearby medical sites that deal with a symptom reported by the consumer.

11.-12. (canceled)

13. The method of claim 10, wherein the medical information provided by the consumer comprises the medical needs of the consumer, information regarding consumer behavior or clinical information of the consumer.

14. (canceled)

15. The method of claim 13, wherein the information to the consumer regarding access to medical care in a medical care system comprises information regarding medical services that are available that respond to the medical needs of the consumer.

16. The method of claim 15, wherein the consumer did not know that the medical services were appropriate to their medical needs, or wherein the consumer did not know that the medical services were offered in a manner that was available to the consumer.

17. (canceled)

18. The method of claim 1, wherein the method further comprises providing a telemedicine session to the consumer, wherein the telemedicine session comprises collection of medical information and medical examination of the consumer by a medical professional by way of a live electronic communication, wherein the live electronic communication is selected from the group consisting of video conference; Internet protocol (IP) telephony; live chat, web site-mobile browser teleconference, videoconference or live chat; smartphone teleconference, videoconference or live chat; teleconference, videoconference or live chat through a dedicated application; and telephone call.

19.-20. (canceled)

21. The method of claim 1, wherein the information requested from the consumer further comprises critical medical information regarding the consumer, wherein if the critical medical information shows that the consumer is in need of critical medical care, the method further comprises sending a message to the consumer recommending pursuit of critical medical care.

22. (canceled)

23. The method of claim 21, wherein the request for information from the consumer regarding critical medical information is performed using an electronic symptom checker through an electronic medium.

24. The method of claim 1, wherein the first communication to the consumer is an electronic communication made through an electronic device selected from the group consisting of a personal desktop computer, a laptop computer, a tablet computer, a cellular telephone, a land line telephone, a facsimile machine, a pager, a radio and a television.

25.-26. (canceled)

27. The method of any one of claim 1, further comprising sending a second communication to the consumer, wherein the second communication comprises information regarding access to medical care in a medical care system, wherein the second communication to the consumer is an electronic communication made through an electronic device selected from the group consisting of a personal desktop computer, a laptop computer, a tablet computer, a cellular telephone, a land line telephone, a facsimile machine, a pager, a radio and a television.

28.-30. (canceled)

31. The method of claim 1, wherein the first electronic communication is provided to the consumer on a web site, through an electronic application, in a phone call, in a facsimile, on a recording provided at a call in number or in a text message.

32. The method of claim 31, wherein the first electronic communication is provided to the consumer on a web site, wherein the consumer accesses the web site as a result of an Internet search on an Internet browser.

33. (canceled)

34. The method of claim 32, wherein the Internet search comprises searching for medical services, wherein the Internet search for medical services comprises a search term selected from the group consisting of medical and online, nurse line, online doctor, medical and phone, medical and remote, talk to a doctor, talk to a nurse, urgent care, immediate care, virtual and medical, web and medical, webcam and medical, clinic, walk-in clinic and online clinic.

35. (canceled)

36. The method of claim 32, wherein the Internet search comprises searching for one or more pathologies or pathological symptoms, selected from the group consisting of abdomen pathologies, allergies, asthma, bladder pathologies, bronchitis, colds, influenza, chronic obstructive pulmonary disease, ear infection, gall bladder pathologies, kidney pathologies, lung pathologies, migraines, mononucleosis, nasal pathologies, pneumonia, sinus infections, oral pathologies, throat pathologies, tonsillitis, urinary tract infections, whooping cough, yeast infections, congestion, cough, fever, headache, incontinence, painful urination, sinus pressure and zinc deficiency.

37.-38. (canceled)

39. The method of claim 1, further comprising comparing the personal information provided by the consumer to a database of information received from consumers, wherein if the information received from the consumer is not already in the database, the information received from the consumer is added to the database.

40. (canceled)

41. The method of claim 39, wherein the consumers are associated with the medical system by being treated by a doctor employed by or associated with the medical system, attending a clinic, hospital or medical center owned or operated by the medical system.

42. The method of claim 41, wherein the database indicates the last time the consumers interacted with the medical care system, wherein the interaction with the medical care system is selected from the group consisting of a visit at a doctor's office, clinic, hospital or medical center that is part of or associated with the medical care system.

43. (canceled)

44. The method of claim 42, wherein consumers that have not interacted with the medical care system for 12 months or more are sent a second communication, wherein the second communication comprises information regarding medical services.

45. (canceled)

46. The method of claim 27, wherein the first or second communication is sent to consumers who have a health plan, wherein the health plan is a health insurance plan that routinely pays a medical system for providing medical services.

47. (canceled)
